(19) United States
(12) Patent Application Publication
(10) Pub. No.: US 2011/0057497 A1
(43) Pub. Date: Mar. 10, 2011

(54) Combination of net and frame

(76) Inventor: Tsan-Ching Wang, Homei (TW)

(21) Appl. No.: 12/585,161

(22) Filed: Sep. 8, 2009

(51) Int. Cl. B60N 2/44; A47C 7/00; A47C 7/02; A47C 7/40; B60N 2/64

(52) U.S. Cl. 297/452.1

(57) ABSTRACT

A combination includes a frame and a net which is made of elastic monofilaments. The frame is composed of a first frame and a second frame, wherein the net has a periphery clamped between the first and second frames. The net is mounted from a top of the first frame and the second frame is connected to the first frame from an underside of the first frame. The combination can be used on seats of exercise devices, wheel chairs or packets. The net provides good ventilation and is flexible for accommodating goods.

### FIELD OF THE INVENTION

The present invention relates to a combination of net and frame, the net is securely connected between first frame and second frame so as to obtain a seat pad, a seat backrest or a pocket.

### BACKGROUND OF THE INVENTION

The conventional exercise bikes generally include a seat which is composed of a seat pad and a backrest so that the user sits on the seat pad to operate the pedals. Most of the seat pads and backrests are made by a foam pad wrapped with a plastic layer. The users operating the exercise bikes sweat a lot and the conventional seats cannot provide proper ventilation feature. A similar situation is experienced for the wheelchair, the user's high temperature cannot be quickly released because of the material and structure of the conventional seat of the wheelchair. Furthermore, when using treadmills, the users need to put their belongings aside but the conventional treadmills do not have such places for the users to put their watches, cellular phones and water bottles.

The present invention intends to provide a combination of a net and a frame, the net is securely connected to the frame so as to provide proper ventilation and the net is strong and flexible to support heavy load.

### SUMMARY OF THE INVENTION

The present invention relates to a combination which comprises a frame composed of a first frame and a second frame, and a net has its periphery clamped between the first and second frames.

The primary object of the present invention is to provide a seat which is used for exercise devices and wheel chair, wherein the net is flexible and provides good ventilation to the users.

Another object of the present invention is to provide a pocket which can be on exercise devices and the users personal belongings are received in the pocket. The apertures of the net allow the users to see the belongings in the pocket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the first embodiment of the combination of the present invention;

FIG. 2 is a partial cross sectional view to show that the net is clamped between the first and second frames of the present invention;

FIG. 3 is a perspective view to show the combination of the present invention used as a seat pad;

FIG. 4 is an exploded view to show second first embodiment of the Combination of the present invention;

FIG. 5 is a partial cross sectional view to show that the net is clamped between the first and second frames of the second embodiment of the present invention;

FIG. 6 is a perspective view to show the combination of the second embodiment of the present invention;

FIG. 7 shows that the combination is used to be the seat pad and the seat backrest;

FIG. 8 shows that the combination is used to be the pocket on a treadmill, and

FIG. 9 shows that the combination is used to be the seat pad of a wheelchair.

### DETAILED DESCRIPTION OF THE PREFERRED EMBODIMENT

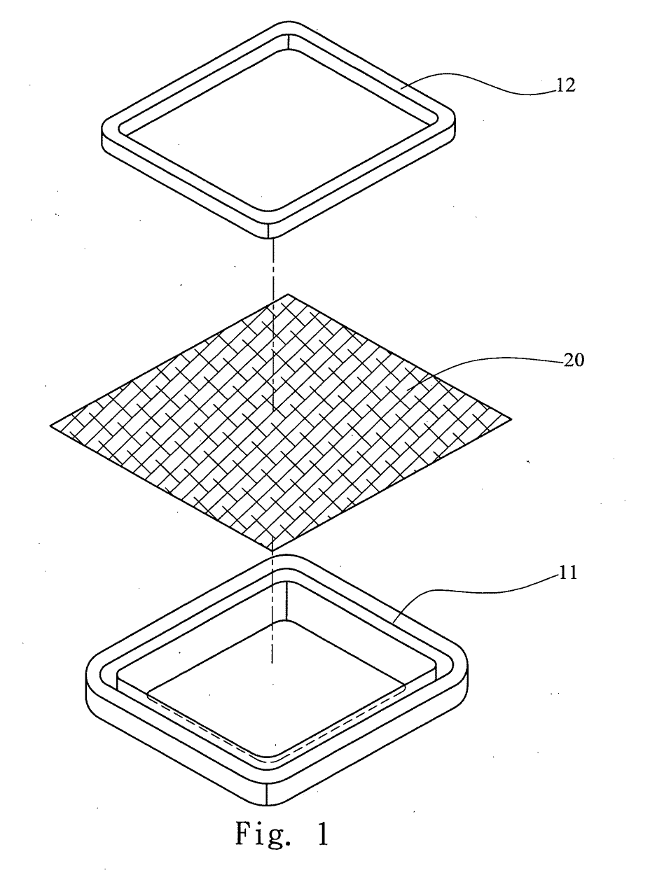

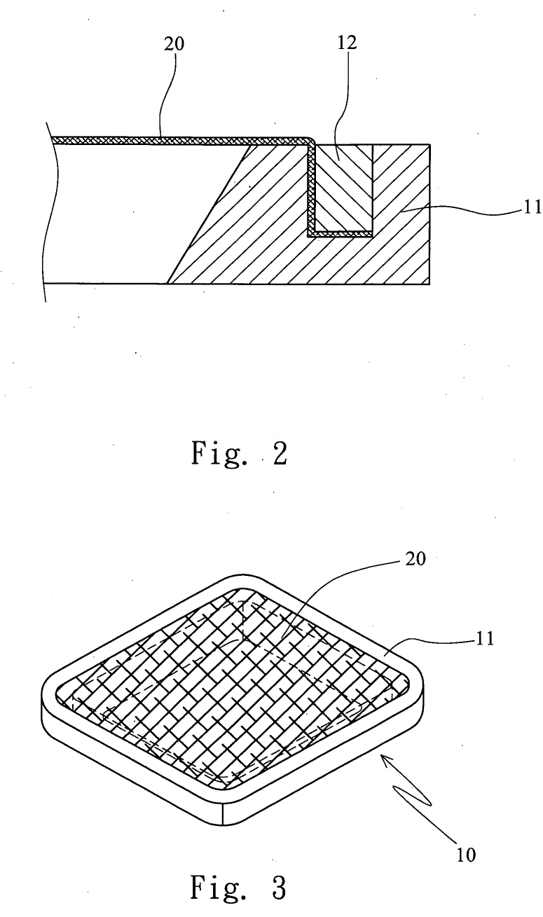

Referring to FIGS. 1 to 3, the first embodiment of the combination of the present invention comprises a frame 10 which is composed of a first frame 11 and a second frame 12, and a net 20 has a periphery thereof clamped between the first and second frames 11, 12. The first frame 11 includes a groove which is sized to receive the second frame 12, and the net 20 is clamped in the groove.

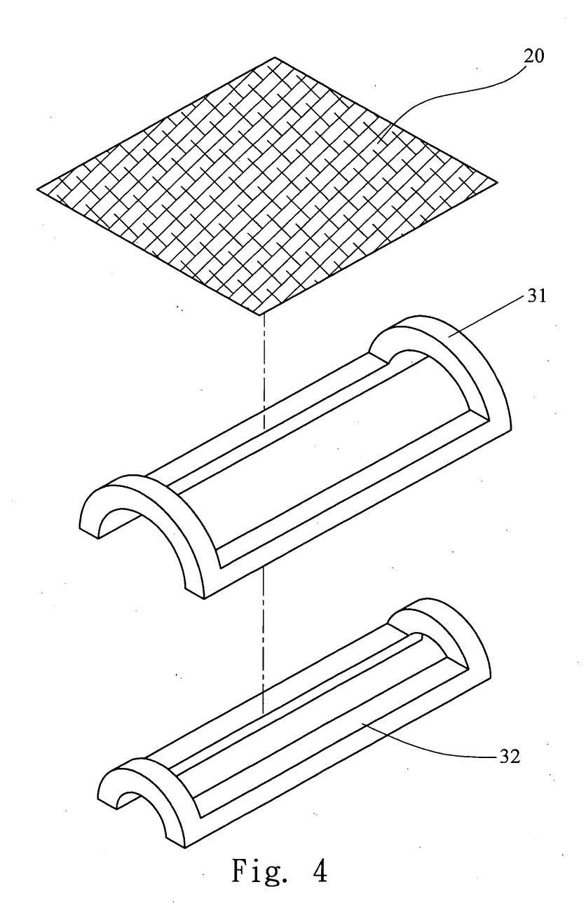

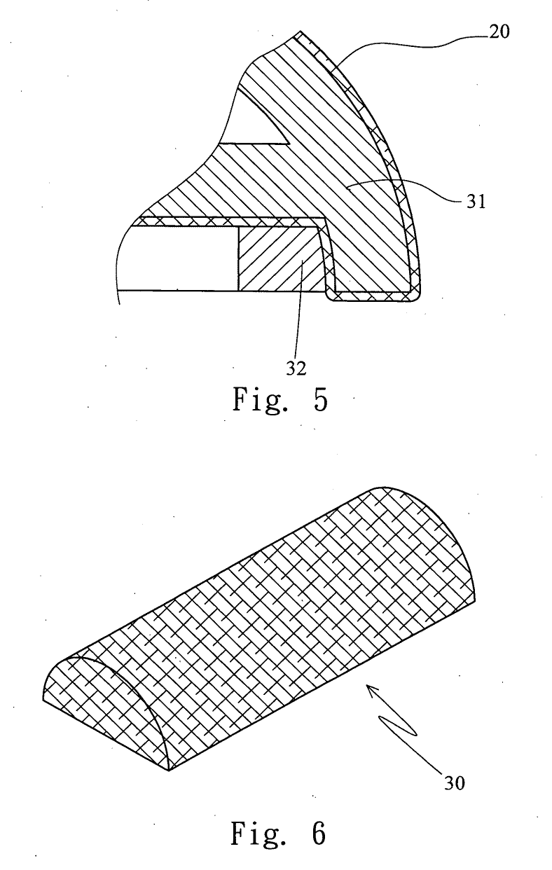

FIGS. 4 to 6 show the second embodiment of the combination of the present invention, wherein the frame 30 is composed of a first frame 31 and a second frame 32, and the net 20 is mounted from a top of the first frame 31 and the second frame 32 is connected to the first frame 31 from an underside of the first frame 31. The periphery of the net 20 is clamped between the first and second frames 31, 32.

It is noted that the net 20 is made of elastic monofilaments which are flexible and strong enough to support heavy load. The apertures of the net 20 provide good ventilation.

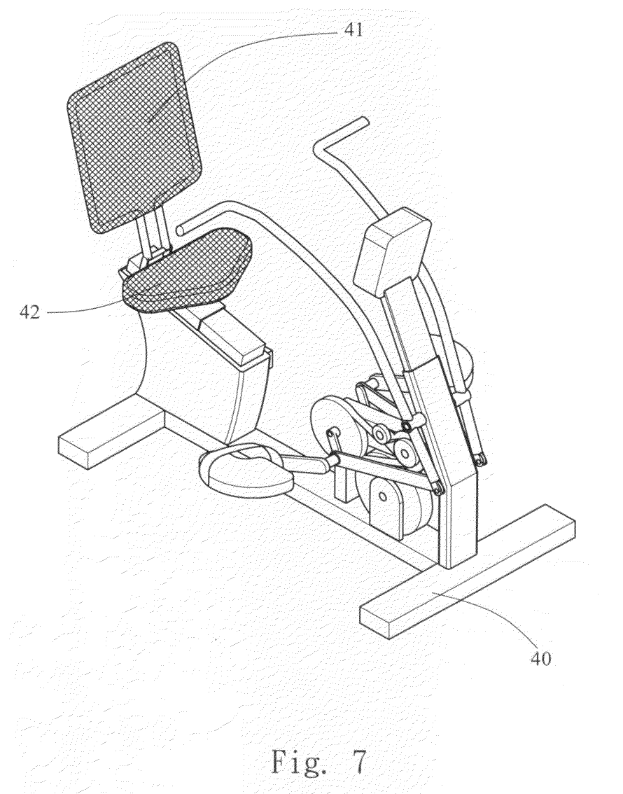

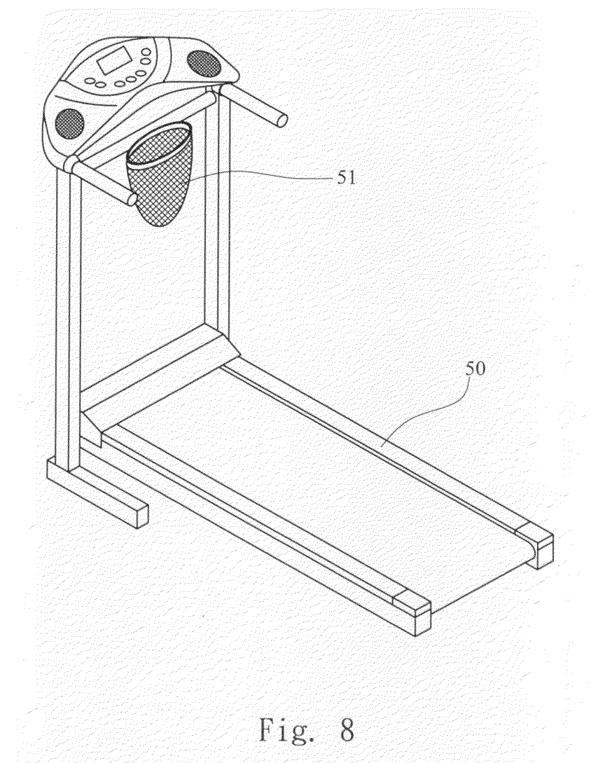

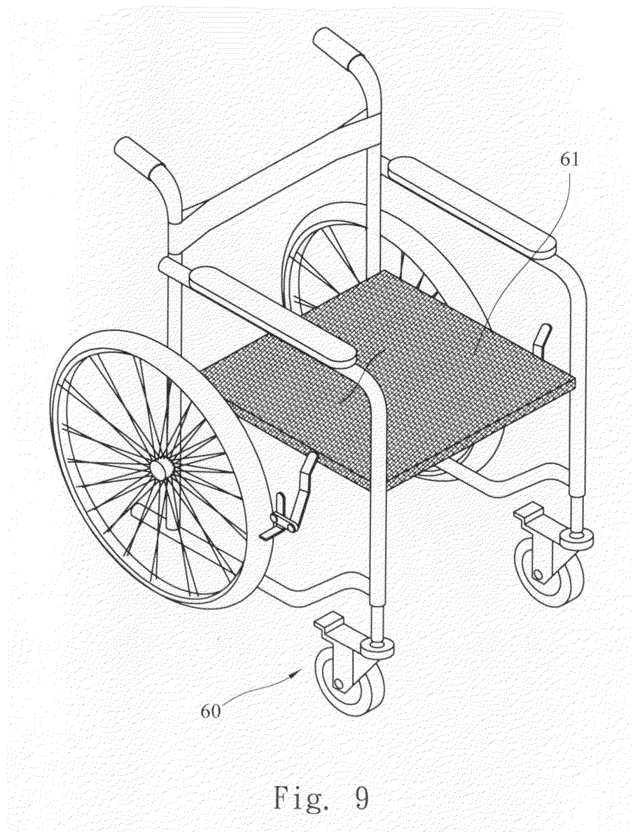

FIG. 7 shows that the combination is used as the seat pad 42 and the seat backrest 41 for an exercise bike 40. FIG. 8 shows that the combination is made to be a pocket 51 which is connected to the treadmill 50 so as to receive the user's personal belongings. FIG. 9 shows that the combination is made to be the seat pad 61 of a wheelchair 60. The seat pad 61 can further be wrapped with a layer of gel to provide comfort sitting experience.

While we have shown and described the embodiment in accordance with the present invention, it should be clear to those skilled in the art that further embodiments may be made without departing from the scope of the present invention.

What is claimed is:

1. A combination comprising:
a frame which is composed of a first frame and a second frame, and
a net having a periphery thereof clamped between the first and second frames.

2. The combination as claimed in claim 1, wherein the net is mounted from a top of the first frame and the second frame is connected to the first frame from an underside of the first frame, the periphery of the net is clamped between the first and second frames.

3. The combination as claimed in claim 1, wherein the net is made of elastic monofilaments.
